(19) United States
(12) Patent Application Publication
(10) Pub. No.: US 2010/0149334 A1
(43) Pub. Date: Jun. 17, 2010

(54) FIXED AND MOBILE VIDEO TRAFFIC ENFORCEMENT

(76) Inventor: Jon Wirsz, Bolingbrook, IL (US)

Correspondence Address: Polster, Lieder, Woodruff & Lucchesi, L.C., 12412 Powerscourt Dr. Suite 200, St. Louis, MO, 63131-3615, US

(21) Appl. No.: 12/638,504

(22) Filed: Dec. 15, 2009

Related U.S. Application Data
(60) Provisional application No. 61/138,331, filed on Dec. 17, 2008.

(51) Int. Cl. H04N 7/18

(52) U.S. Cl. 348/143; 348/E07.085

(57) ABSTRACT

A system and method providing a police officer the ability to capture and review traffic violations observed using one or more strategically located cameras. The system incorporates a database of state and local motor vehicle laws and when the officer determines a violation has occurred the system automatically fills in the relevant statute or code for the violation, the correct legal language describing the violation, and the fine for that violation. Driver's license and vehicle information is also automatically filled in. The officer can override the issuance of a citation and indicate that only a warning or Reminder be issued instead. The citation, warning or Reminder notice is saved in the system for further processing and subsequent mailing. The system now transmits the citation, warning or Reminder notice data to servers at the service provider for mailing, the municipal department which collects the fines, as well as the police department's traffic division, for inclusion in their respective databases. This reduces paperwork, and data entry processing, further saving time and expense. Whether a citation, warning or Reminder notice is issued, the system and method of the invention significantly expand the area of coverage of a police officer in monitoring traffic and detecting violations, and allows the officer to issue more citations, warnings or Reminders within a given time period than is now possible. This makes the officer more efficient and potentially increases revenue because of the issuance of more citations. More importantly, it makes drivers more conscious of their actions and promotes vehicular safety.

### CROSS-REFERENCE TO RELATED APPLICATIONS

U.S. provisional patent application 61/138,331 filed Dec. 17, 2008.

### STATEMENT REGARDING FEDERALLY SPONSORED RESEARCH

Not Applicable.

### BACKGROUND OF THE INVENTION

This invention relates to the issuance of speeding tickets and tickets for other traffic law violations; and, more particularly, to a method that allows the police to more quickly issue tickets for detected violations thereby enabling the police to issue more tickets within a given period as well as provide better enforcement of traffic laws, and generate more revenue for municipalities.

A major function of police departments is to enforce the traffic laws of a city or municipality. This includes not only stopping and issuing tickets to those driving in excess of posted speed limits, but also apprehending people driving recklessly, running stop signs, not properly signaling turns or lane changes, etc. Since most of these violations, while significant, do not require that the driver of the vehicle be arrested and jailed, the typical action taken against them is the issuance of a ticket which will result in them paying a monetary fine to the city.

Enforcing traffic laws takes a significant amount of time. As shown in FIG. 1, the conventional process involves deployment of a police officer who first observes occurrence of a traffic violation (an “event”). Having observed the event, the officer must then pursue and stop the vehicle. Having caught the offender, the officer must now issue a ticket to the driver of the vehicle. Once the offender has been given the ticket and released to go on their way, the officer now redeploys and starts looking for another offender.

This process is time consuming. A study by the Portland, Oregon Police Department found that during the above described process, which represents about one hour of activity; the issuance of a ticket, including actually writing the ticket, takes, on average, only 5-7 minutes. The remaining time is spent first, in observing the event, and then pursuit, and redeployment after writing the ticket. Accordingly, a police officer is typically able to issue only between 1-2 tickets an hour. This, in turn, means many offenders are able to avoid being caught and ticketed because police officers are otherwise engaged in pursuing motorists, ticketing those drivers, and redeploying. By redesigning the process FIG. 2, as described hereinafter, this time can be used to produce greater results.

It will be understood that besides the safety aspects of stopping and ticketing people who are breaking the speed limit or otherwise violating traffic laws, the revenue from issuing tickets represents a significant revenue source to many municipalities. This means that if police officers were provided a better, more efficient way to identify and ticket violators, not only would streets be made safer, but a city's income from tickets would also substantially increase.

### BRIEF SUMMARY OF THE INVENTION

The present invention is directed to a system and method that provides a police officer the ability to capture, at the touch of a screen, many types of traffic violations (an “event”) observed using one or more strategically located video speed cameras. In response to an event, one of three types of notices can be issued: the standard uniform citation, which carries a fine; a warning such as the customary written warning; and, a reminder notice which is the equivalent of a customary verbal warning that focuses on safety and driver education. Having all three types of notices available allows the officer to continue his customary roll of both enforcer and educator.

Importantly, the system is specifically designed to not only function within the framework of existing statutes that maintain the traditional recording and reporting of the number of tickets accumulated, etc., along with the points normally applied, or other consequences, but also has the flexibility to function with newer types of administrative ticketing processes now being used.

The system is programmed to process the event by way of the officer selecting it from a list of events displayed on a touch screen accessed by the officer. The program incorporates a database of state and local motor vehicle laws. When the officer selects the event, the program automatically fills in the relevant statute or code for the violation, the correct legal language describing the violation, and a base fine assessed for that violation. If the violation merits an increased fine, the system automatically adds the appropriate increased amount to the base fine. Driver's license and vehicle information is also automatically filled in. The officer has the ability to override the issuance of a citation and indicate that only a warning or reminder notice be sent to the offender. The citation, warning or reminder notice is saved in the system for further processing and subsequent mailing. The system transmits citation, warning, and reminder notice data to servers for both a municipal department which collects the fines, and the police department's traffic division, for inclusion in their respective databases. This reduces subsequent paperwork, and data entry processing, saving administrative time and expense.

Whether a citation, warning, or reminder notice is issued, the system and method of the invention significantly expand the area of coverage of a police officer in monitoring traffic and detecting violations, and allows the officer to issue more citations, warnings, or reminders within a given time period than is now possible. This makes the officer more efficient and potentially increases revenue because of the issuance of more citations. More importantly, it makes drivers more conscious of their actions and promotes vehicular safety.

Other objects and features of the invention will be in part apparent or in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a flow chart of a five (5) part process currently used by police to apprehend traffic law offenders and issue citations;

FIG. 2 is a flow chart of a two (2) part process of how traffic law offenses are detected using the system and method of the present invention;

FIG. 3 illustrates a representative deployment of the system;

FIG. 4 is a flow chart of how citations are issued and fines paid in accordance with the system and method of the present invention;

FIG. 5 is a flow chart similar to that of FIG. 4 for administrative tickets;

FIG. 6 is a flow chart illustrating the use of reminders, warnings, and citations notices;

FIG. 7 illustrates a 4-way split screen monitor used by police for detecting events;

FIG. 8 illustrates use of a Review/Edit screen feature of the monitor; and,

FIG. 9 illustrates a Law Library screen feature of the monitor.

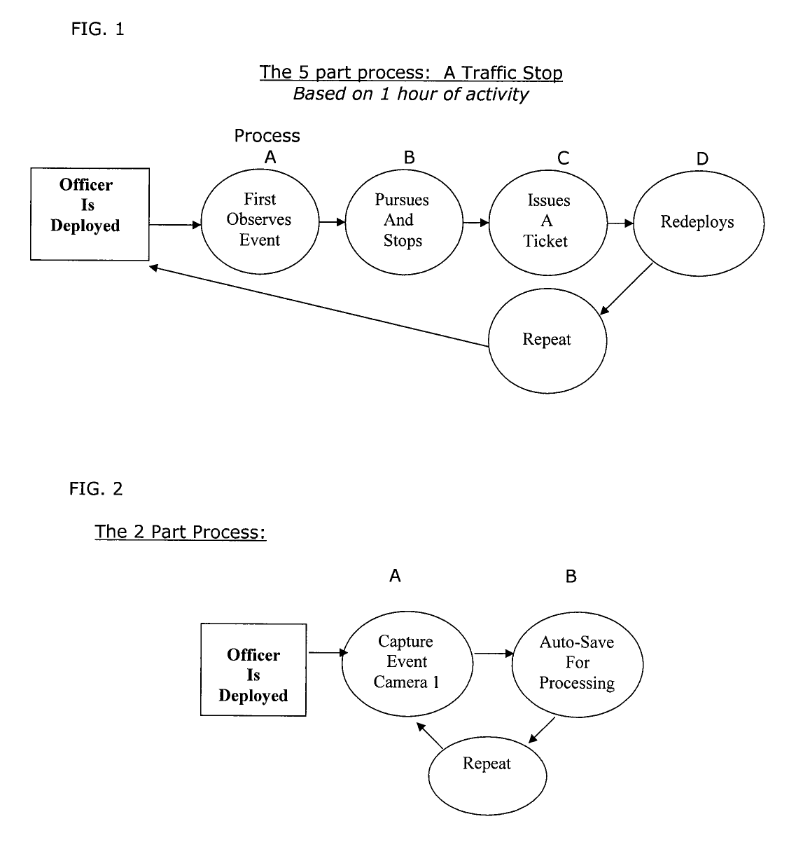

Corresponding reference characters indicate corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

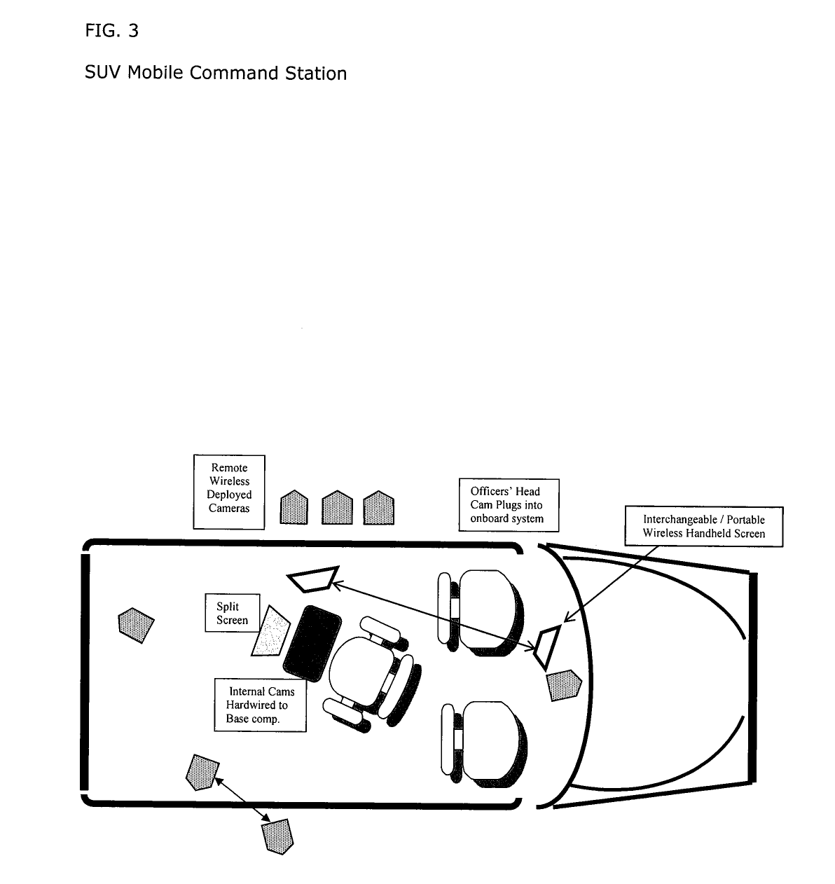

In accordance with the invention, and as shown in FIG. 3, some police officers may be deployed as they currently are to monitor traffic and stop and ticket those violating traffic laws. However, the present invention provides a remote monitoring capability in which a number of cameras are deployed throughout an area to monitor vehicular traffic. Those skilled in the art will understand that each of these cameras can be moved from one location to another. An exemplary camera setup is as follows:

Camera #1—vehicle rear mounted and intended to operate through the rear window of the vehicle;

Camera #2—vehicle rear mounted and deployable so to operate through the side windows of the vehicle, or deployed outside of the vehicle and used with a portable system;

Camera #3—remote cameras which can be monitored individually or collectively (these can be mounted on telephone poles, light poles, etc.);

camera #4—forward monitoring camera that provides forward observation and also has multiple capabilities such as described with respect to camera #2; and,

Camera #5—portable (backpack) cameras which can be moved about the area under surveillance.

Camera #6—head or helmet camera worn by the officer.

The cameras can be used alone, or in combination with each other, or with other types of detection including radar and lasers.

The system is a wireless, self-contained system and the video imagery obtained from each camera is transmitted via a wireless system, including antennas, to a command vehicle manned by a police officer and used as described hereinafter. Thus, while some officers continue to pursue and stop offenders as the need arises, the officer in the command vehicle effectively enlarges the police department's “footprint” even though he does not move about the area. It will be understood by those skilled in the art that as additional cameras and capabilities are employed, the system becomes even more dynamic

Once in place, the system allows for constant monitoring of the traffic environment. Transmitting of remote monitoring is done at low resolution while target events are saved at the scene in high resolution automatically or on command. The officer in the command vehicle saves the video imagery related to specific events (violations) at the touch of a screen. This then allows him to subsequently recall events (using a touch screen capability or push of a button) and process the violations, even while on the move from one location to another.

All of the cameras are sufficiently sensitive that they can do automatic license plate reading (ALPR) for individual events in a wide variety of weather conditions. This ALPR feature allows constant monitoring of vehicle plates. When a hit is made, the system automatically saves the event, and alerts the officer, allowing the officer to immediately view the vehicle, plate identification and cause of the alert. The system automatically checks on a vehicle's plates and their listed owner, the system will access the state's division of motor vehicles (DMV) and the National Criminal Information Center (NCIC) databases as well as other databases. This process is constant and ongoing. The officer can also do random checks on plates if desired.

A main advantage of the system is that it now provides police the ability to have a single officer view video from all the cameras in real time, capture specific events and process them from a central location without undue time constraints. This is particularly advantageous in states where physical police presence is not required when a violation occurs in order to issue a citation or warning; although cameras deployed as remote systems can be monitored at the scene to comply with certain state's laws for issuing citations for speeding violations.

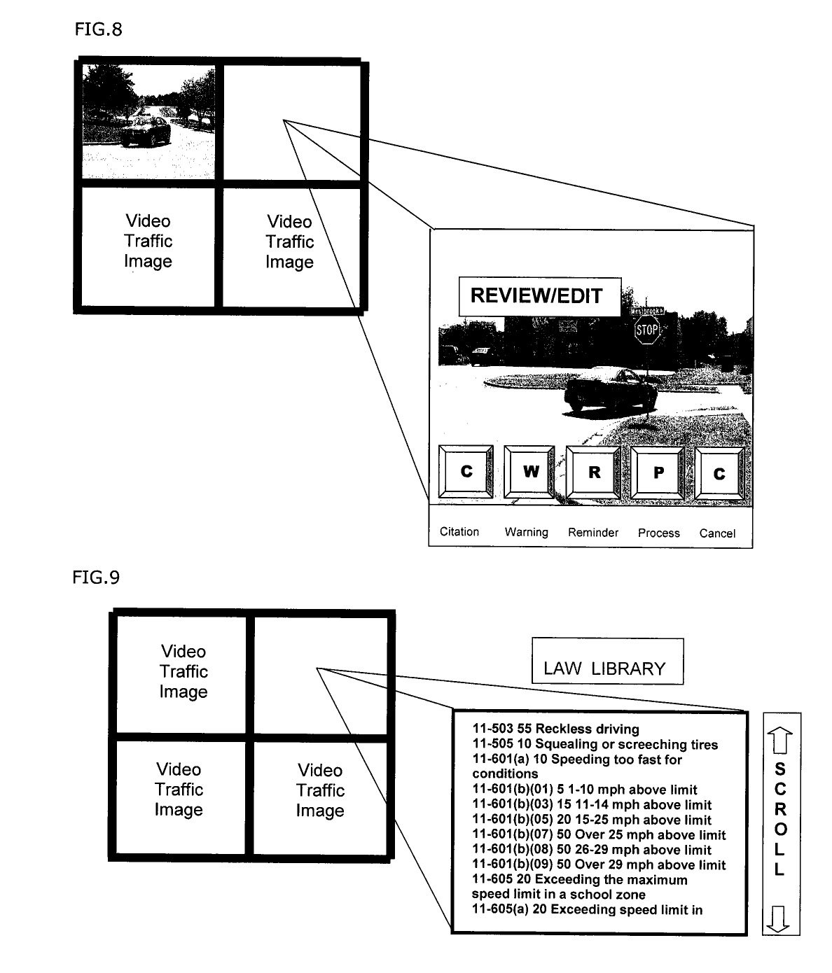

The system installed within the command vehicle is programmed to allow the officer to review stored or captured video of an event obtained from any of the cameras. As shown in FIG. 7, the main viewing screen is a 4-way split screen with each sector displaying real-time, live video from a separate camera. When the officer decides to capture an event, he does so by simply touching the appropriate screen sector. This “touch-to-capture” feature saves a 20 second video file to the computer's hard drive. The system can store up to 20 seconds of video from each camera in a temporary memory cache. The 20-second loop is constantly renewing as the camera monitors live events. When an officer decides to capture an event, the current 20-second loop is now saved for subsequent review, edit, and processing. When the camera is turned-off, all of the information stored in the temporary memory is erased. For purposes of review, the Review/Edit feature shown in FIG. 8 allows the saved 20-second clip to be automatically replayed on the screen. The officer edits the clip by touching the screen at the moment when the violation occurs. This establishes a center point about which the computer edits the clip from 20 seconds down to 12 seconds; there now being six seconds of video both before and after the event (i.e., center point). The screen now also displays the options to be used to complete the ticketing process with the officer selecting the appropriate button for issuing a citation, warning, or a reminder notice.

The system is programmed to identify multiple types of violations within an event and incorporates a database of motor vehicle laws for the state and locality where the system is used. As shown in FIG. 9, this Law Library feature is displayed on one sector of the screen when selected by the officer again using the touch screen feature. In processing the event, the officer designates the violation from those listed in the Law Library printout, again using a touch screen feature. Those skilled in the art will understand that more than one violation can be selected from the list of violations presented.

The program automatically enters the statute number or ordnance, the proper legal language identifying the violation, and the basic fine for that violation. If the violation is such that the fine should be enhanced or increased; for example, speeding in a school zone, the system automatically increases the fine to the appropriate amount. Driver's license, vehicle information, and any other pertinent information (e.g., identification of officer preparing the citation) are filled in automatically. When completed, the officer saves the information in the system for wireless transmission to the police department's traffic violations bureau and the municipality's department which processes citations. For this purpose, the system has a wireless capability. A citation is then automatically issued and sent to the vehicle owner. The system can further provide court scheduling for those violations requiring more than the mailing in of a fine, and it can also generate traffic analysis reports.

If appropriate, the officer can designate an event as meriting the issuance of a Reminder, a warning (no fine) rather than a citation (a fine) and the program processes the information accordingly. The Reminder and warning notices will serve to focus on safety and education. The feature of the method of the invention provides communities with the ability to have a powerful influence on motivational factors that help determine safer driving behavior. With communication being the key, a Reminder notice provides a new and friendlier method of intervention.

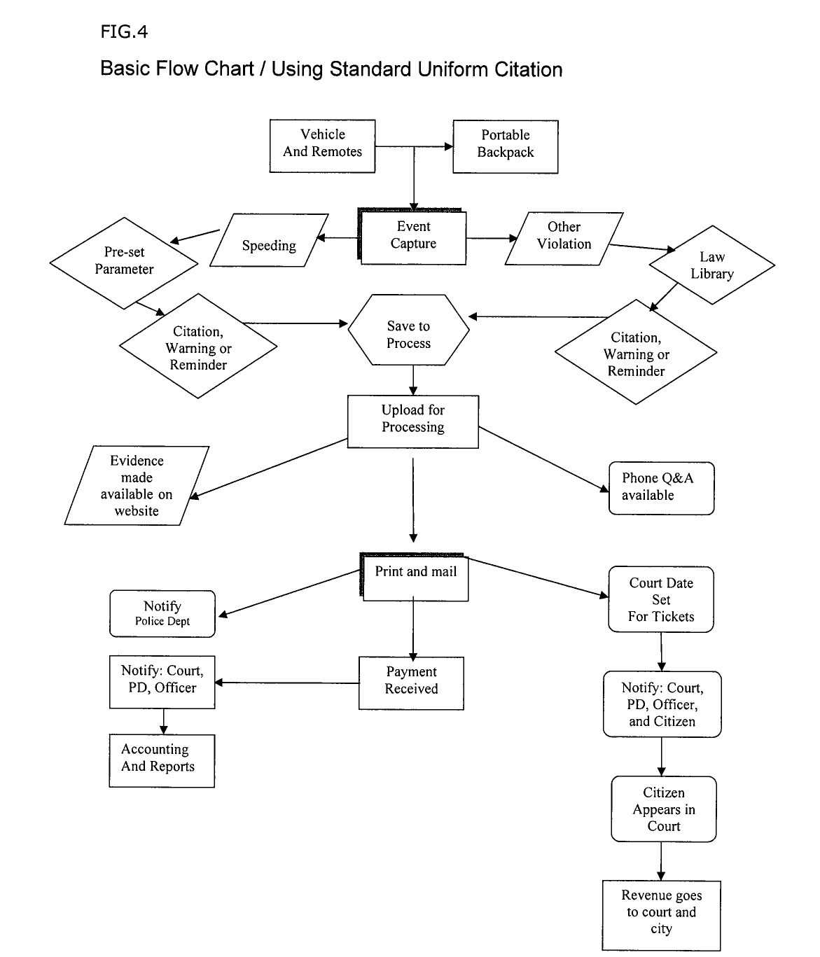

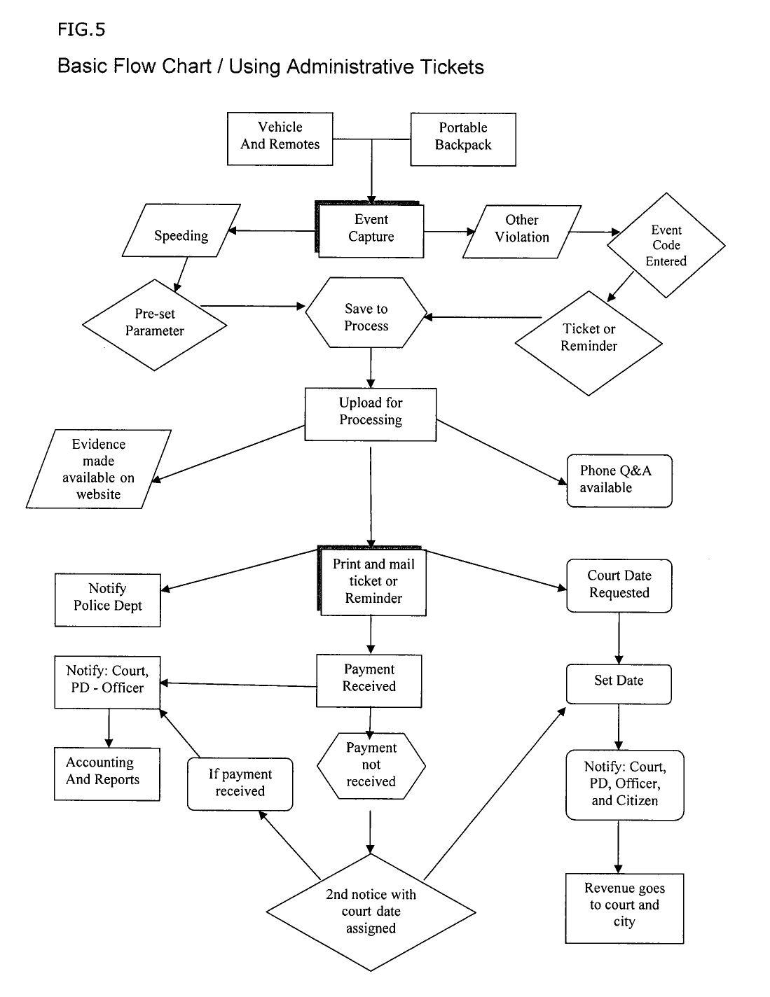

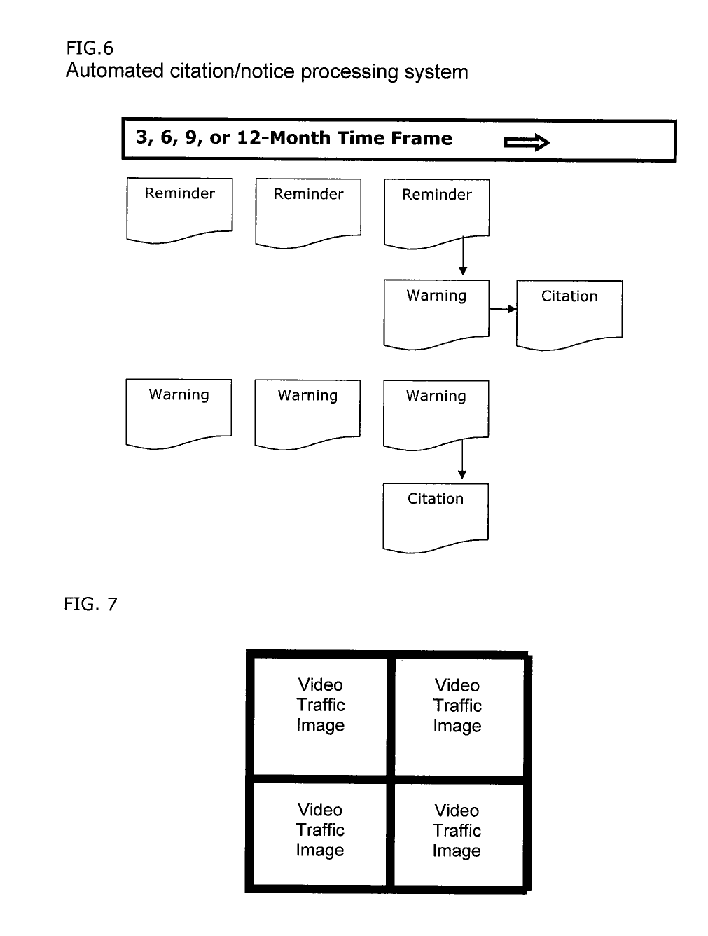

The top half of a reminder notice appears as a standard citation providing defendant, vehicle, violation and fine information. But, the bottom half of the notice focuses on instructive issues providing statistics, images and other appropriate resources encouraging safer driving behavior. A typical application of the system, as shown in FIG. 6, allows officers to select the appropriate notice without concern for the number of notices an individual has received in the past. For example, a police department can select a time frame in which an individual can receive a predetermined number of notices. After that limit is reached, a Reminder or warning now automatically becomes a fine. Or, the number and type of notices can trigger a fine. For example, if a driver is allowed only two Reminders within a 12-month time frame, a third Reminder issued during that period automatically becomes a warning, and any Reminder or warning after that becomes a standard citation. A third warning within the 12-month period would also automatically become a fine. It will be understood that each municipality or police department can establish its own parameters. The process with respect to issuance of a standard uniform citation is shown in FIG. 4, and that for an administrative or warning notice is shown in FIG. 5.

Use of the system and method of the invention now allows a single officer to process a large number of violations within the same period of time he was previously able to process only a single violation. He further has the capability of issuing numerous citations or warnings without having the amount of paperwork he previously had to deal with, using sophisticated, though straightforward data entry and processing. The police department, in turn, can monitor a larger area with fewer officers than it previously needed, and the municipality may see increased revenue because more citations can be written. Finally, once motorists become aware of the increased monitoring, and are exposed to the new method of notification, they hopefully will alter any of their unsafe driving habits which should result in fewer accidents and injuries.

In addition to the complete in-house processing and mailing of citations, the system can provide on-line evidence of a violation. This includes, for example, a 10-12 second stored video clip of video of the violation, and is in addition to the DMV and NCIC look up for the 50 states, collection histories for previous violations and other archived records.

Since the system is a wireless, portable camera system, in addition to traffic monitoring, it also lends itself to other, sometimes covert, police operations. For example, the system will allow two officers to operate as a team moving through a community, one in the vehicle and one on foot, to create a large footprint within the community. Remote cameras carried by the officers can then be used for security and neighborhood crime watch activities. The officers can then do on-site event review of an incident that occurs since they will have a review and edit capability with the system. They also have complete mobility with the base command monitoring station, which can be used with a central command center.

Additional advantages of the system include:
A significant impact on safety, both traffic and neighborhood;
Low (or no) cost to operate because of increased revenues from the greater number of citations being written;
Greater, full-time police presence because fewer officers are required for traffic patrol and writing citations;
Effectively expands the police department budget;
Increased effectiveness of government grants used for traffic control;
overcomes objection to the use of unmanned speed cameras, while still expanding their impact (for example, in Illinois, the use of unmanned speed cameras is denied to local governments and municipalities and retained for the exclusive use of the state);
can be included with other programs such as school bus safety;
Use of warnings for marginal violations that normally go unchallenged can help change driving habits;
consolidates existing technologies and expands a single traffic officer's “footprint” in the community;
Significantly increases police officers' efficiency compared with that of other systems;
can be deployed in a myriad of ways and is readily adapted to the needs of the community where it is used;
Where applicable, relieves a police dispatcher from having to handle queries from officers for license checks;
Significantly reduce the amount of police paperwork and data entry; and,
is easily set up and ready for deployment.

Although the above description is with respect to a mobile, i.e., vehicle based command station, it will be understood that a fixed command station can also be employed. The command station, whether fixed or mobile, manages all traffic video and still camera operations. The stations can operate together or independently of each other. The monitors employed in a command station provide split screen views from the various cameras and the officer can toggle back and forth between cameras. As previously noted, the monitors have a touch screen capability.

The types of violations (events) which can be captured by the cameras and viewed by an officer for issuing citations or warnings include, without limitation:

a) speeding;

b) no valid registration;

c) improper passing;

d) improper traffic lane usage;

e) passing on the shoulder;

f) improper use of or failure to use a turn signal;

g) failure to reduce speed;

h) changing lanes without a signal;

i) failure to obey a stop sign;

j) disregarding a traffic control device;

k) littering.

With respect to speeding violations, the officer presets speed violation parameters, and when the threshold is reached, an alert sounds so the officer can witness the event. Then, the officer touches the screen and trips it to the Review/Edit feature previously discussed. For example, an officer could set the threshold to 6 mph above the posted limit; and, upon review, would determine which type of notice should be sent to a driver based on the severity of the violation.

The screen of a portable or handheld monitor will also auto revert to the appropriate camera image when a parameter is breeched.

With respect to stop signs and traffic lights, the system is programmed so that cameras monitoring these detect when a vehicle's speed reduces to zero. This indicates a “safe” stop. However, if the vehicle speed does not go to zero, this indicates a violation and triggers event capture.

Finally, it will be appreciated by those skilled in the art that current camera based systems for traffic enforcement often require special legislation for their use in an administrative ticketing process. This legislation, which circumvents traditional processes and penalties in order to accommodate the service providers, also removes the police officer from frontline enforcement of traffic statutes. The method and system of the p[resent invention do not require any special legislation for their effective operation in detecting and ticketing traffic law violators.

In view of the above, it will be seen that the several objects and advantages of the present disclosure have been achieved and other advantageous results have been obtained.

Having thus described the invention, what is claimed and desired to be secured by Letters Patent is:

1. A method of mobile traffic photo enforcement comprising:
deploying a plurality of video cameras throughout an area, each camera continuously obtaining video imagery of vehicles moving throughout the area;
transmitting video imagery from each camera to a central location for viewing by a police officer, the officer viewing displayed imagery from each camera to detect an event including a possible traffic violation;
identifying a specific event such as a traffic violation and saving video of the event to a memory,
for each event accessing a computer database to retrieve vehicle information based upon license plate indicia of the vehicle involved in the event and displayed on the video, and information as to the traffic violation committed by the person operating the vehicle; and,
issuing a reminder notice, warning notice or citation to the person operating the vehicle, whereby the police officer can issue multiple reminder notices, warning notices or citations without having to be physically present at each location where an event occurred thereby providing more comprehensive enforcement of traffic laws within the area using a minimum number of police officers.

2. The method of claim 1 in which at least one camera is stationary and at least one camera is mobile.

3. The method of claim 2 in which the mobile camera is installed on a police vehicle.

4. The method of claim 1 in which the central location is a vehicle continuously movable throughout the area.

5. The method of claim 1 in which each camera presents streaming video on a monitor for viewing by the police officer and each monitor has a touch screen capability for the officer to identify a detected event by touching the appropriate monitor where the event is displayed.

6. The method of claim 5 in which simultaneously occurring events are simultaneously displayed on the monitors and the police officer selects each event by touching each appropriate monitor.

7. The method of claim 6 in which the memory stores video of a detected event from a monitor selected by the officer, the memory storing video from a predetermined time before the event occurred to a predetermined time thereafter.

8. The method of claim 7 further including transmitting video of an event to at least one other location for simultaneous viewing of the event at that location.

9. The method of claim 8 in which the video can be processed and edited at each location to which it is transmitted.

10. The method of claim 5 further including using multiple sensors to further detect events and the location where each event occurred.

11. The method of claim 10 in which the multiple sensors include: radar, lasers, and ground position sensors (GPS).

12. The method of claim 10 further including and automatic license plate recognition (APLR) software for recognizing license plate indicia displayed on a monitor.

13. The method of claim 2 in which video cameras are installed in a mobile command vehicle, a base command station, a patrol vehicle, a motorcycle, and a portable backpack worn by a police officer.

14. The method of claim 1 further including transmitting the video and other information related to the event, reminder notice, warning notice or citation issued to a database used for traffic related offenses and used to provide information to a police officer about the event if a subsequent event involving the vehicle or its operator occurs.

15. The method of claim 14 further including transmitting the video and other information related to the event to a database used for determining driver behavior patterns in an area so to formulate strategies for modifying such behavior.

16. The method of claim 1 which functions within the framework of existing traffic statutes, and reporting of traffic offenses and the consequences of such offenses, as well as with newer administrative ticketing processes.

17. The method of claim 1 which does not require special legislation in order to be operated by appropriate law enforcement personnel for issuing reminder notice, warning notice or citation.
